(19) United States
(12) Patent Application Publication
(10) Pub. No.: US 2014/0272875 A1
(43) Pub. Date: Sep. 18, 2014

(54) APPLIANCE FOR SIMULATING THE CHEWING ACTION OF A MAMMAL

(71) Applicants: Olivier Francois, Chamalieres (FR); Alain Woda, Ceyrat (FR); Monique Alric, Saint Flour L'etang (FR); Lionel Batier, Paslieres (FR); Sylvain Denis, Clermont (FR); François Callardo, Clermont (FR); Marie Agnès Peyron, Chamalieres (FR); Anne Mishellany-Dutour, Perignat-Les-Sarlieve (FR)

(72) Inventors: Olivier Francois, Chamalieres (FR); Alain Woda, Ceyrat (FR); Monique Alric, Saint Flour L'etang (FR); Lionel Batier, Paslieres (FR); Sylvain Denis, Clermont (FR); François Callardo, Clermont (FR); Marie Agnès Peyron, Chamalieres (FR); Anne Mishellany-Dutour, Perignat-Les-Sarlieve (FR)

(21) Appl. No.: 12/678,449

(22) PCT Filed: Sep. 10, 2008
(86) PCT No.: PCT/FR08/01267

§ 371 Date: Feb. 8, 2012

(30) Foreign Application Priority Data
Sep. 17, 2007 (FR) 0706519

(51) Int. Cl. G09B 23/32

(52) U.S. Cl. CPC G09B 23/32
USPC 434/270

(57) ABSTRACT

The invention relates to an appliance for simulating the chewing action of a mammal, said appliance comprising two elements (21, 22) simulating a mobile lower maxilla and a fixed upper maxilla. The two elements are formed by two parallel disks (21, 22) aligned on a common axis (A-A′), a face of each disk, facing the other disk (21, 22), being provided with at least one raised part (31, 33) projecting from said face. The appliance comprises means (16, 17,18,19) for driving at least one (21) of said disks in relation to the other disk (22), rotationally about the common axis (A-A′) and in translation (12,13,14) parallel to said axis.

The invention relates to an appliance for simulating the chewing action of a mammal. “Mammal” is used to refer to a higher mammal such as a human being, a domestic animal, a pet or livestock.

An appliance of this type makes it possible to simulate chewing action, i.e. to reproduce the mechanical and chemical phenomena found in the buccal cavity of the mammal. These phenomena lead to the production of an alimentary bolus from foodstuffs or other products due to the action of the teeth, the saliva and the movements of the tongue. This alimentary bolus is subsequently swallowed and directed into the first stomach sac.

The simulation of phenomena of this type allows a better understanding of the physical, chemical, rheological and/or organoleptic properties of the alimentary bolus. It makes it possible to develop foodstuffs and/or medicines in a form which promotes the ingestion thereof and/or the development of the organoleptic qualities thereof. It also makes it possible to develop materials for use in the mouth, such as dental reconstruction materials.

US-A-2001/0045475 discloses a device in two parts, comprising a sealed, thermostated chamber in which two mixing blades rotate in opposite directions. One of the blades rotates more quickly than the other. These blades are provided, on the edges thereof, with plastics material members which make it possible to have no clearance created between the blades and to crush the particles which form the alimentary bolus without degrading the blades. A device of this type is used in particular for pulverising foodstuffs and revealing the volatile substances which are released during this degradation. This device does not allow reproduction of the complex movements of chewing, these being crushing movements, shearing movements and movements of the tongue to displace the ground material.

WO-A-8 905 970 discloses a machine for testing a resilient material, in particular chewing gum. This machine comprises a base on which a sample to be tested is placed. A piston is positioned above the sample. This piston is movable vertically and in rotation. The sample is crushed by the rotating piston. This machine does not make it possible to simulate the phenomena associated with the chewing of the foodstuffs and the properties of the alimentary bolus.

A machine disclosed by C. Salles et al. in Journal of food engineering 82, (2007) pages 189-198 is also known. This machine reproduces the movements of the dental arches and of the tongue. For this purpose, it comprises a first cylinder which has a conical end and is movable in translation in a second cylinder which is movable in translation and in rotation. The internal cylinder reproduces the movements of the tongue, and the external cylinder reproduces those of the lower jaw or mandible. The end of the external cylinder is provided with artificial teeth reproducing the lower dental arch. During operation, the teeth of the external cylinder come into contact with the artificial teeth reproducing the upper dental arch, which are disposed on the upper part of the machine. The upper dental arch is stationary relative to the lower dental arch. A machine of this type provides an anatomical reproduction of the teeth and a simulation of the functions of the tongue and jaws. This complex and bulky machine requires the external and internal cylinders of the lower jaw to be driven in rotation and in translation by three different motors. Moreover, the anatomical reproduction of the elements forming the buccal cavity has the effect of making mathematical modelling of the phenomena particularly difficult because of the complexity of working with a plurality of parameters. Moreover, the anatomical reproduction of the elements of the buccal cavity makes it difficult to recover the whole of the alimentary bolus.

The present invention aims in particular to overcome these drawbacks, by proposing an appliance for simulating chewing action having a simple construction and operating in a manner which allows simple modelling of the movements of the jaws and tongue.

The invention accordingly relates to an appliance for simulating the chewing action of a mammal, comprising two members simulating a movable lower jaw and a fixed upper jaw, characterised in that the two members are formed by two parallel discs aligned on a common axis, a face of each disc, facing the other disc, being provided with at least one raised portion projecting from said face, and in that the appliance comprises means for driving at least one of said discs in rotation about the common axis and in translation parallel to said axis with respect to the other disc.

The relative movements of the discs with respect to one another make it possible to bring into contact raised portions which simulate the crushing and shearing of the foodstuffs between the teeth. The presence of raised portions having a suitable shape allows centring and displacement of the mass which is to be ground between the discs. In this manner, a single type of member, namely the two discs with the raised portions, makes it possible to simulate the action of the teeth and tongue during chewing. Consequently, an appliance of this type is easy to produce and to maintain and takes up little space. It makes it easy to model the chewing parameters, such as the force and speed and displacement of the lower jaw.

In accordance with advantageous but non-essential features of the invention, the appliance may incorporate one or more of the following features:
The raised portion is in the form of a truncated triangular prism with bevelled walls.
Each disc is provided with two diametrically disposed raised portions.
The raised portions of each disc are disposed with the points thereof opposite one another and spaced in such a way as to provide a planar central space therebetween.
The members simulating the jaws are inserted into a chewing chamber of a cylindrical shape having a circular cross-section.
One end of the chamber is closed by a removable end plate.
The end opposite the end receiving the plate is suitable for allowing a fluted shaft to pass through.
The fluted shaft is centred on a longitudinal axis of the chamber.
The shaft is driven in rotation by a toothed pulley and in translation by a jack.
A force sensor is interposed between the fluted shaft and the jack.
A restoring member is interposed between the end plate and a disc, this member exerting on this disc a resilient force directed towards the other disc.

The invention will be better understood and further advantages thereof will become clearer upon reading the following description of an embodiment of an appliance according to the invention, provided purely by way of example and with reference to the appended drawings, in which:

FIG. 1 is a perspective view of an appliance for simulating chewing according to the invention,

FIG. 2 is a longitudinal section, on a larger scale, along the line II-II in FIG. 1,

FIG. 3 is a perspective view on a larger scale of the two discs of the appliance of FIGS. 1 and 2, which discs simulate the upper and lower jaws, in a position spaced apart from one another, and

FIGS. 4, 5 and 6 are schematic drawings showing the two discs of FIG. 3, in the close-up position and viewed from the side in the direction of the arrow IV, on a different scale and in different positions during an operating cycle of the appliance.

The appliance 1 shown in FIG. 1 is mounted on a base 2 formed, in this case, of three profiles disposed in an H. The appliance 1 comprises a block 3, in a parallelepiped shape, formed of a rigid, physically and chemically inert and thermally stable material. In this example, this block is formed from stainless steel, for example of grade 316L stainless steel. This block 3 is hollow and delimits a chewing chamber 4. One end of the chamber 4 is delimited by an end plate 5, which is removable. This removable plate forms a cover 5 which is held in place by a set of hooks 6 and tensioners 7 which are known per se.

In variants, other devices for holding this plate 5 in position may be used. For example, said plate may be hinge-mounted and be held in place by bolts or by threaded rods with butterfly-type nuts.

In the upper part, this chamber 4 is provided with an aperture 8, which can be closed by a plug 9 and which opens onto the top of the block 3. This aperture 8 allows products, in particular foodstuffs which are to be ground, to be introduced into the chamber 4. Another aperture 80, closed by a plug 90, makes it possible to introduce into the chamber 4 products which allow the chemical decomposition of the foodstuffs and the formation of a lubricated alimentary bolus, i.e. an alimentary bolus with a low coefficient of friction, making it easier for the alimentary bolus to pass through the oropharyngeal sphincters. A product of this type may for example be a product which simulates saliva, known as artificial saliva. It may be introduced progressively, for example using a pump-type system, or all at once at the start of an operating cycle.

The upper part of the chamber 4 may also be provided with a member for removing the air contained in this chamber. It is possible if required to provide other apertures for access to the chamber in order to introduce other products or sensors simultaneously with the introduction of the product which simulates saliva. The overall shape of the chamber 4 is that of a circular cylinder, with an internal diameter of approximately 7 cm and a length of between 14 and 15 cm, making it possible for the chewing chamber to have a volume of approximately 15 cm³. This volume generally corresponds to the average volume of an air-filled buccal cavity of a human being, i.e. to the average volume of the buccal cavity when the individual has his mouth closed.

The end 10 of the chamber 4, opposite that provided by the plate 5, is provided with a through-hole 11 making it possible for a fluted shaft 12 to pass through. The fluted shaft 12 is aligned along a main longitudinal axis A-A′ of the chamber 4. This fluted shaft 12 is connected by an end 120 to a jack 13 which is actuated by an electric motor 14. The jack 13 produces a reciprocating translational movement of the shaft 12, along the double-headed arrow F₁. A force sensor 15 is interposed between the end 120 of the fluted shaft 12 and the jack 13. In an embodiment which is not shown, the fluted shaft is also provided with a torque sensor.

The fluted shaft 12 passes through a device 16 for driving it in rotation, which device is driven by a second electric motor 17. It is advantageous for the torque of the motor 17 to be adjustable. The device 16 comprises, for example, a means for guidance by ball bearings 18 and a means for driving in rotation formed by a toothed pulley 19.

In this way, the fluted shaft 12 can be displaced in translation along the axis A-A′, from one end of the chamber 4 towards the other end, whilst being driven in rotation about the axis A-A′, along the double-headed arrow F₂, by the pulley 19.

The end 121 of the fluted shaft 12 which opens into the chewing chamber 4 is provided with a polytetrafluoroethylene base 20. In a variant, this base is made from a metal of which the external peripheral edge is coated with polytetrafluoroethylene. The dimensions of this base 20 are such as to take up the whole of the cross-section of the chamber 4. The external peripheral edge of the base 20 provides the seal between the base 20 and the wall of the chamber 4 during the translational and/or rotational movements of the shaft 12.

This base supports a first disc 21 forming a member for simulating the lower jaw. The base 20 is fixed to the shaft 12 and centred on the axis A-A′. In this way, the base 20 and the disc 21 form a movable base for the chamber 4.

A second disc 22 which reproduces the upper jaw is identical to the first disc 21. It is supported by a base 23 made of polytetrafluoroethylene. In a variant, the base 23 is made from a metal of which the external peripheral edge is coated with polytetrafluoroethylene. The bases 20 and 23 are of similar dimensions. The rear face of the base 23, i.e. the face thereof opposite the chamber 4 and the disc 22, is provided with a recess 24 for receiving at least one resilient restoring member 25, in the present case a flat spiral compression spring. In a variant, a pneumatic restoring member may be used. The spring 25 is removable and this makes it possible for example to change the restoring force as required.

The assembly of the base 23 and disc 22 is held in contact with the end plate 5 of the chamber 4 due to the action of the spring 25. The distance between the end position of the spring 25, in which said spring is relaxed or under the maximum compression, corresponds to the possible path for the restoration of position by the base 23, and thus by the disc 22 supported on said base. This restoration path is varied by changing the spring 25. A longitudinal slot 27 provided in the block 3 makes maneuvering possible and allows a screw 26 to be kept screwed into the base 23. In this way, the support 23 and the disc 22 are fixed in rotation. The slot 27 only allows the base 23 and the disc 22 to be displaced in translation, in a direction parallel to the axis A-A′.

In an embodiment which is not shown, the path of the screw 26 in the slot 27 is adjusted, for example with a set of stops. An adjustable path of the disc 22 makes it possible to adjust the maximum useful volume of the chamber 4.

The two discs 21 and 22 respectively reproducing the lower jaw and the upper jaw are centred on the axis A-A′. The discs 21 and 22 are mutually parallel and perpendicular to the longitudinal axis A-A′.

The disc 22 connected to the plate 5 is fixed in rotation relative to the block 3, but is movable in translation in the chamber 4 in a direction parallel to the double-headed arrow F₁. The path thereof corresponds to the maximum restoration path of the spring 25.

The opposing faces of the discs 21 and 22 are denoted as 28 and 29 respectively. The faces 28 and 29 are planar over the majority of the area thereof. They are each provided with at least one raised portion. In this case, the faces 28 and 29 are each provided with two diametrically arranged raised portions 30 and 31, 32 and 33 respectively. The raised portions 30 to 33 are identical. Therefore, the discs 21 and 22 are interchangeable.

In embodiments which are not shown, the number of raised portions on the faces 28 and 29 may be greater than two for each disc. For example, four or six raised portions may be provided for each disc.

Since the discs are identical, the description thereof is given with reference to the disc 22 which can be seen in FIG. 3.

The raised portions 32 and 33 are in the overall shape of a truncated triangular prism. The points 34 and 35 of these raised portions are closed off at an angle of approximately 30°. They are disposed in the vicinity of the geometric centre C of the face 29 of the disc 22 from which the raised portions project. The small base 36 or 37 of each raised portion 32 or 33 is at a tangent to the edge of the disc 22. These raised portions have a height of approximately 6 mm.

In an embodiment which is not shown, the raised portions are of a different shape. For example, they may be in the shape of a truncated cone and/or in the shape of tooth stumps. In this way, they are able to support dental reconstruction products.

The raised portions 32 and 33 have lateral sides which form contact regions between raised portions when raised portions of the two discs 21 and 22 are in mutual contact. These sides exhibit a double bevel. The side of the raised portion 32 which can be seen in FIG. 3 comprises a first bevel 38 which forms an angle of between 40 and 50°, advantageously of approximately 45°, with the planar portion of the face 29 and a second bevel 39 which is coincident with the face 29, is rounded and forms an angle of between 25 and 35°, advantageously of approximately 30°, with said face.

The other side (not shown) of the raised portion 32 is also provided with a double bevel, at the same angle. The raised portion 33 opposite the raised portion 32 also has lateral sides 40, 41 and 42, 43 exhibiting a double bevel, at the same angles as the double bevels of the raised portion 32. In FIG. 3, only the double bevel 40, 41 is shown.

These bevels 38 to 43, which are equivalent, form surfaces known as active chewing surfaces, i.e. surfaces capable of producing a double mechanical stress of the shearing and crushing type. This double stress reproduces that which is exerted on foodstuffs by the teeth of a mammal.

In an operating cycle of the appliance, the rest position is the position in which the discs 21, 22 are at the maximum distance from one another, and the assembly is stationary. This position makes it possible to have a useful volume of the chamber 4 close to the maximum available volume, i.e. close to the maximum volume of the buccal cavity. After the introduction of these products, i.e. the elements and/or products to be tested, via the aperture 8 and of the artificial saliva via the aperture 80, the fluted shaft 12 is pushed to the right in FIG. 2. This movement, carried out by the jack 13, has the effect of moving the disc 21 reproducing the lower jaw towards the disc 22 reproducing the upper jaw. The disc 22, being connected to the plate 5 via the base 23 and the spring 25, is stationary. This movement simulates the movement causing aggregation of the foodstuffs to be crushed by the teeth.

The products to be chewed are therefore confined between the discs 21 and 22. In this position, these products have not yet been subjected to any mechanical damage. This position corresponds generally to a buccal cavity filling position, without any chewing motion.

Setting in rotation the disc 21, reproducing the lower jaw, makes it possible to initiate the actual simulation of the chewing via mechanical actions which lead to the formation of the alimentary bolus. For this purpose, the movement in translation and in rotation of the disc 21, associated with the restoration in the opposite direction of the disc 22 due to the action of the spring 25, makes it possible to bring about successive contacts between the active chewing surfaces, i.e. between the different bevels of the raised portions 30 to 33, as is shown schematically in FIGS. 4, 5 and 6.

In a first position shown in FIG. 4, the raised portions of the discs are oriented at 90° to one another. In this case, the upper face of each raised portion of a disc 21 or 22 is in contact with the central planar part P, located between two raised portions, of the other disc 22 or 21. In this first position, a raised portion 30 to 33 crushes the foodstuffs against a planar face P of the opposite disc.

In a second position, shown in FIG. 5, the raised portions of each disc are in contact with one another. Rotating the disc 21 in either direction makes it possible to bring particular bevels of the raised portions into contact with one another. In this case, there is contact between bevelled sides of two raised portions in contact and a part of the point of the raised portions. Bearing in mind the angle of the bevel, relative to the planar part of the discs, this contact is accompanied by sliding of the raised portions against one another, the disc 21 pushing the disc 22 against the force of the spring 25. The movement of the disc 22 is thus oriented in the same direction as the movement in translation of the disc 21.

This displacement of the disc 22 towards the plate 5 has the effect of compressing the restoring spring 25 and of displacing the disc 22 slightly towards the plate 5. This movement is opposed by the action of the spring 25 which counters the displacement of the disc 22 towards the plate 5. The disc 21 is held in contact with the disc 22 by the jack 13, the advance of which can be controlled as a function of data provided by the force sensor 15.

Contact between the two discs 21, 22 is therefore maintained at a defined pressure. During this contact, there is a relative displacement of the active chewing surfaces in contact. In others words, shearing of the foodstuffs is carried out between the sides of the raised portions of the discs which slide against one another with controlled shearing and compression forces.

The third position shown in FIG. 6 is a transitory position. The sliding movement of the bevelled walls of the raised portions against one another continues until the discs 21, 22 are only in contact via the planar upper faces of the respective raised portions thereof. In this position, the planar faces of the discs, between the raised portions, are relatively remote from one another. This transitory position does not produce any crushing or shearing effect on the foodstuffs. Instead, the raised portions which are in contact via the upper faces define an open cavity O therebetween. This cavity O is in an approximately central position relative to the raised portions 30 to 33 of the discs 21 and 22. The discs 21 and 22 are thus firmly in contact, the spring 25 being compressed by the maximum amount.

This cavity O forms a region which makes it possible to centre the more or less thoroughly ground mass of the foodstuffs and to aggregate it between the discs. As the rotation of the disc 21 continues, the apparatus passes from this third, transitional position into a position equivalent to the second position shown in FIG. 5, in which the raised portions 30 to 33 are in contact via the opposite walls to those which are in contact in FIG. 5.

The rotational movement continues until a position equivalent to the first position, shown in FIG. 4, is reached.

Thus, during a full cycle of rotation of the disc 21, the raised portions 30 to 33 pass successively through three positions respectively reproducing crushing, shearing and aggregation of the alimentary bolus.

This succession of positions makes it possible to reproduce the stresses found during natural chewing, namely a first, crushing action and a second, shearing action on the foodstuffs by the teeth, these two actions being almost simultaneous, followed by a movement by the tongue to aggregate the alimentary fragments.

The presence of the force sensor makes it possible, via different devices such as a ballistic device, a closed loop device or a machine learning device, to control the movement and the forces exerted by the fluted shaft 12 on the disc 21. Via this control, the crushing and shear forces are controlled precisely and constantly. Thus, it is possible with the simulation appliance according to the invention to collect data on the stresses undergone by the foodstuffs, to add products, and to model the chewing, while permanently adjusting the pressure exerted by the discs 21 and 22 as a function of the type of foodstuffs to be ground and of the already ground mass.

Advantageously, the temperature of the assembly, i.e. the appliance 1 or at least the chamber 4 and the block 3, is controlled, for example by means of a resistance wire or a double-walled block 3 in which a heat transfer fluid circulates.

It is also possible to provide, at the end plate 5, an overflow facilitating the collection of the alimentary bolus once the tests have been carried out. The fact that the end of the chamber can be opened completely also facilitates cleaning and/or sterilisation thereof, as well as the collection of the alimentary bolus.

It is also possible to provide for this apparatus to be used in a vertical position, instead of in a horizontal position as shown.

1. Appliance for simulating the chewing action of a mammal, comprising two members simulating a movable lower jaw and a fixed upper jaw, characterised in that the two members are formed by two parallel discs aligned on a common axis, a face of each disc, facing the other disc, being provided with at least one raised portion projecting from said face, and in that the appliance comprises means for driving at least one of said discs in rotation about the common axis and in translation parallel to said axis with respect to the other disc.

2. Appliance according to claim 1, characterised in that the raised portion is in the form of a truncated triangular prism with bevelled walls.

3. Appliance according to claim 1, characterised in that each disc is provided with two diametrically disposed raised portions.

4. Appliance according to claim 3, characterised in that the raised portions of each disc are disposed with the points thereof opposite one another and spaced in such a way as to provide a planar central space between them.

5. Appliance according to claim 1, characterised in that the members simulating the jaws are inserted into a chewing chamber of a cylindrical shape having a circular cross-section.

6. Appliance according to claim 5, characterised in that one end of the chamber is closed by a removable end plate.

7. Appliance according to claim 6, characterised in that the end opposite the end receiving the plate is suitable for allowing a fluted shaft to pass through.

8. Appliance according to claim 7, characterised in that the fluted shaft is centred on a longitudinal axis of the chamber.

9. Appliance according to claim 7, characterised in that the shaft is driven in rotation by a toothed pulley and in translation by a jack.

10. Appliance according to claim 9, characterised in that a force sensor is interposed between the fluted shaft and the jack.

11. Appliance according to claim 6, characterised in that a restoring member is interposed between the end plate and a disc, this member exerting on this disc a resilient force directed towards the other disc.
